(19) United States
(12) Patent Application Publication
(10) Pub. No.: US 2008/0268281 A1
(43) Pub. Date: Oct. 30, 2008

(54) Shield Components With Enhanced Thermal and Mechanical Stability

(76) Inventors: Quan Bai, Dublin, CA (US); Patrick Rymer, Livermore, CA (US); Jose Gonzalez, San Lorenzo, CA (US); Gary Groshong, Brentwood, CA (US)

Correspondence Address: HARVEY S. KAUGET;PHELPS DUNBAR, LLP, 100 S. ASHLEY DRIVE, SUITE 1900, TAMPA, FL, 33602-5311, US

(21) Appl. No.: 11/741,375

(22) Filed: Apr. 27, 2007

(51) Int. Cl. B32B 15/01

(52) U.S. Cl. 428/650; 428/660; 428/666; 428/685; 428/686

(57) ABSTRACT

The invented shield components are used for a plasma processing system to adhere deposition materials or process residuals during wafer processing, thus preventing excessive wafer contamination, even when exposed to high temperatures. One embodiment of the invented shields consists of a reaction barrier layer to separate the underlying substrate from the overlying spray coating to prevent solid-state chemical reaction between the substrate and the coating. Another embodiment of the invented shields consists of a substrate and a coating with a substrate-coating combination chosen to allow no new solid-state phase to form at the interface. The invented shields have well-bonded materials interfaces that preserve thermal and mechanical stability under high temperature conditions in a plasma processing system for the containment of deposition contaminates.

### FIELD OF THE INVENTION

The present invention generally relates to semiconductor processing, and more specifically to a shield employed in a plasma processing system.

### BACKGROUND

This invention concerns new types of shields to be used in a plasma vapor deposition (PVD) process chamber for the processing of wafers in, for example, the semiconductor industry or the magnetic recording disk drive industry. A PVD process chamber generally consists of a target, a plasma environment, a wafer that is to be film deposited, shields, and other chamber components. The target provides the source of material to be deposited onto the wafer. The plasma environment, facilitated by an energized gas, drives the deposition process of transferring the target material to the surface of the wafer. An undesirable side effect is that target material also deposits on other places inside the chamber. The shields are intended to provide an envelope to contain the depositing material that does not deposit on the wafer.

An ideal shield would retain unlimited amounts of deposited materials falling onto it and would not allow materials to emit from it since the substances leaving the shield are a source of contamination for the wafer. However, a shield in practice has a limited life which often determines the production time of a PVD chamber. Beyond the end of shield life, a large amount of deposited materials and other process residuals on a shield may generate internal stress high enough to exceed the strengths of bonded materials which causes flaking and or the emission of a substance off the shield. The emitted substance leaving the shield may land on the wafer and cause defects and/or yield loss.

Shield components commonly used in PVD process chambers are fabricated from metal or ceramic materials. For example, a PVD tantalum deposition chamber may include shields such as an upper floating shield, an inner shield, a lower shield, a shutter disk, a cover ring, a deposition ring and a clamp ring. Commonly, shields are fabricated from a substrate material of stainless steel due to its excellent mechanical and chemical properties as well as its low cost. Ceramic materials, such as alumina or zirconia, have also been used as shield substrates in some cases (e.g., deposition rings) where high electrical conductivity of the substrate is undesirable. Titanium has also been used as a substrate for some shields (e.g., cover rings or shutter disks) where the low thermal expansion characteristics of titanium are desired in shield components located very close to the wafer being processed. It is believed that the reduced thermal expansion of titanium compared to stainless steel may reduce the generation of contaminating particles due to the stress in the deposited material caused by the expansion.

The surface of the components in a PVD process chamber is often treated so as to improve the adhesion of the deposited material since many materials deposited by a PVD process (“deposition material”) do not adhere well to smooth metal or ceramic components. Roughening the surface often improves the adhesion of deposited material to the component. Such roughening may be accomplished by means such as grit-blasting. Further improvement in the adhesion of deposited material may sometimes be obtained by coating the component with another material, such as aluminum, as described, e.g., Micro Magazine in March 2001 by Rosenberg, and U.S. Pat. No. 6,227,435 issued on May 8, 2001, to Lazarz et al. Usually, the coating itself has a rough surface finish which helps improve the mechanical interlocking between the deposited material and the coating. Ductile coatings, like aluminum, may also help to dissipate through plastic deformation a portion of the accumulated stress from the overlying deposited material. As long as the coating adheres well to the substrate material of the component, a substantial amount of deposited material can be accumulated without unduly contaminating wafers that are being processed. Typically, rough metal coatings may be applied to component surfaces by thermal spray methods such as twin-wire arc spraying or plasma spraying.

Once a certain amount of deposited material (which may incorporate other process residuals) has been accumulated on the shield components in a process chamber, the operation of the process chamber must cease temporarily until the shield components are replaced. If production continued without replacing the shield components, defective wafers would be produced due to contamination from material emitted from the shield components. Frequently, the sputtering target is replaced at the same time as the shield components are replaced to minimize lost production time of the costly equipment.

After replacing the shield components, and possibly the sputter target, the deposition chamber must be conditioned before production of wafers can continue. Often such chamber conditioning consists of a pump-down and bake-out procedure, followed by a target burn-in procedure. A typical pump-down and bake-out procedure evacuates the air in the chamber by means of vacuum pumps, thus reducing the pressure in the chamber. Then, the interior of the chamber and interior components may be heated above ambient temperature to hasten the achievement of even lower chamber pressures. Once a sufficiently low chamber pressure has been achieved, a target burn-in procedure sputters material from the surface of the target to prepare the target suitably for production processing. Often, the entire process of replacing the shield components and the sputtering target, then performing the pump-down and bake-out procedure, and then performing the target burn-in procedure may take many hours, e.g., 6 to 18 hours. Since this chamber conditioning process represents lost production time, it is desirable to minimize the total time spent on these activities.

One way to reduce the lost production time associated with replacement of shield components and/or sputtering targets is to reduce the time used for either or both of the chamber conditioning steps. For example, target burn-in is sometimes performed by alternating periods of deposition (“plasma on”) with periods during which the plasma is off. This “plasma-off” time may be needed to prevent the chamber or some of its components from being heated by the plasma to a temperature high enough to cause damage. However, if the percentage of “plasma off” time can be decreased, the total non-productive time of the equipment would be reduced.

It has been found; however, that shield components made according to standard methods may fail when such an approach is taken to reducing the target burn-in time. For example, if the ratio of “plasma on” to “plasma off” times of the burn-in procedure is increased from about 1.05 to about 1.38 when standard shield components fabricated from stainless steel coated with an aluminum arc spray coating are used in a typical PVD chamber for depositing tantalum, the shields fail much earlier than normal. The shields fail not during the burn-in procedure, but later during routine wafer processing. In other words, the burn-in procedure is completed without incident and normal production processing of wafers is started. After processing less than about one third of the number of wafers usually processed between shield replacements, the shield's aluminum coating and overlying deposition material delaminate over large areas of the shield. This failure forces immediate replacement of the shield components and also may result in scrapped wafers.

Since the interior chamber components exposed to the plasma are heated by the plasma, shortening of “plasma-off” times during the burn-in procedure causes these components to rise to a higher temperature. Since most of the shield components are poorly cooled, the maximum temperatures reached can be quite high. Analysis on shields that delaminated early after experiencing a fast burn-in cycle discovered a layer of an aluminum-iron-nickel intermetallic phase formed at the interface between the stainless-steel substrate and the aluminum are spray coating. This observation is consistent with published Fe—Al—Ni ternary phase diagram which indicated the formation of the Al—Fe—Ni intermetallic phase above about 400° C., as described by Guha et al. on Materials Characterization 34:181-188 published in 1995. When coupons made from stainless steel coated with aluminum arc spray were heated to various temperatures and then analyzed, they exhibited the same type of intermetallic phase after exposure to temperatures above about 400° C.

It was also observed that adjacent to the intermetallic phase layer, a region with a large population of voids of a few micrometers in size is formed in the aluminum spray coating. Such a high-porosity layer was not observed in either shields or coupons only subjected to temperatures lower than 400° C. The formation of the voids is thought to be a result of local depletion of aluminum atoms (or collections of atomic vacancies) that diffused into the intermetallic phase layer as the intermetallic phase layer grows. Similar observations of such pore formation were also found in solid-state reaction studies on other bi-materials, as described, e.g., Schmalzried in Solid-State Reaction published in 1981. This intermetallic phase layer with a large population of voids weakens the adhesion between the aluminum arc spray coating and the underlying stainless steel substrate, thus leading to delamination.

In the case of a PVD wafer process with a fast burn-in cycle, shields which attain a temperature above approximately 400° C. will contain an intermetallic phase layer and a void-populated layer after the burn-in. As a result, these shields will have a reduced cohesive strength between the aluminum arc spray coating and the stainless steel substrate. Upon the subsequent wafer processing, deposition materials and other process residuals accumulate on the surface of the shields and the internal stress increases, thereby acting to pull the aluminum coating apart from the stainless steel substrate along the weakened and void-populated layer. As a result, this prior art shield will fail at lower internal stress before its normal chamber life due to delamination along the weakened layer.

Thus, it is desirable to obtain a shield component, that after exposure to the higher temperatures caused by a shortened burn-in procedure, which is capable of operating for a normal number of wafers without excessive contamination to those wafers.

Nothing in the prior art provides the benefits attendant with the present invention.

Therefore, it is an object of the present invention to provide an improvement which overcomes the inadequacies of the prior art devices and which is a significant contribution to the advancement of the semiconductor processing art.

Another object of the present invention is to provide a shield component for a plasma processing system comprising a substrate, a reaction barrier layer, and a top coating.

Yet another object of the present invention is to provide a shield component for a plasma processing system comprising a substrate and a coating wherein said substrate does not chemically react with said coating to form a new intermetallic phase at a temperature range of about 400 to 660° C.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

The present invention provides a process shield for a PVD process chamber that can be exposed to temperatures above about 400° C. (but below the melting temperature of aluminum around 660° C.) without substantial weakening of the adhesion between the coating and the substrate (or intermetallic phase formation at the substrate-coating interface). Thus, the shields of the present invention can be used, for example, in a PVD process chamber utilizing a fast burn-in cycle to gain more wafer production time without sacrificing shield life. The invented shields have two embodiments to satisfy different deposition, refurbishment and economic requirements, i.e., a double coating embodiment and a single coating embodiment.

In regard to the double coating embodiment, the shield has a substrate material of stainless steel, a reaction barrier layer and a twin-wire arc sprayed top coating. The reaction barrier layer has a thickness of about 0.001 to about 0.010 inches that covers over the grit-blasted textured stainless steel substrate. The reaction barrier layer can be produced by a thermal spray method such as a plasma spray or a twin-wire arc spray or by a plating method. The reaction barrier layer comprises at least one of the following materials: titanium, a non-magnetic nickel-chromium alloy (major constituents of around 70% by weight of nickel and around 20% by weight of chromium) or a non-magnetic cobalt-chromium-molybdenum alloy (major constituents of around 60% by weight of cobalt, around 26% by weight of chromium and around 7% by weight of molybdenum). The top coating has a thickness of about 0.005 to about 0.020 inches or, more preferably, about 0.008 to about 0.012 inches which covers over the reaction barrier layer and comprises aluminum. The top coating can be applied by a thermal spray method such as a twin-wire arc spray or a plasma spray.

The material (Ti, Ni—Cr alloy or Co—Cr—Mo alloy) for the reaction barrier layer is so chosen that it will not lead to an intermetallic phase formation between the stainless steel substrate and the barrier layer or between the aluminum top coating and the barrier layer at temperatures in the range of about 400 to 660° C. In addition, the reaction barrier layer will not reduce the adhesion strength between the two interfaces. Thus, in comparison to a prior art shield whose mechanical property deteriorates after subjecting it to a temperature above about 400° C., the new shield of the present invention can be used at extended chamber temperatures without sacrificing shield life. Furthermore, the material used for the reaction barrier layer is non-magnetic. Thus, the addition of this reaction barrier layer does not affect the shield's RF or magnetic characteristics.

When coating the stainless steel substrate with the reaction barrier material of the present invention, it is desirable to maintain a minimum thickness of at least about 0.001 inches so as to maintain the barrier function of this layer. Also, it is desirable for the surface roughness of the reaction barrier layer to be greater than about 300 microinches to ensure adequate adhesion to the top coating when fabricating the top coating by thermal spray. Depending on spray angle between the normal of spray surface and the axis of the spray gun and on spray parameters (e.g., carrier gas pressure), the surface roughness average of the top coating typically lies between about 1000 to about 2000 microinches for arc spray or between about 500 and about 1000 microinches for plasma spray.

In regard to the single coating embodiment, the shield consists of a substrate material and a coating with substrate-coating material combinations chosen to allow no new intermetallic phase to form at the substrate-coating interface at elevated temperatures of around 400 to around 660° C. The following substrate-coating material combinations are used:
(1) The shield has a substrate material of stainless steel and a thermal-spray coating of around 0.005 to around 0.020 inches thick or, more preferably, about 0.008 to about 0.012 inches thick of one of the following materials: titanium, a non-magnetic nickel-chromium alloy (major constituents of around 70% by weight of nickel and around 20% by weight of chromium) or a non-magnetic cobalt-chromium-molybdenum alloy (major constituents of around 60% by weight of cobalt, around 26% by weight of chromium and around 7% by weight of molybdenum);
(2) the shield has a substrate material of titanium and a thermal-spray coating of aluminum with a thickness around 0.005 to around 0.020 inches thick or, more preferably, about 0.008 to 0.012 inches thick; or
(3) the shield has a substrate material of aluminum and a thermal-spray coating of titanium with a thickness around 0.005 to around 0.020 inches thick or, more preferably, about 0.008 to about 0.012 inches thick.

The material combinations between the substrate and coating as stated above do not lead to intermetallic phase formation at temperatures around 400 to around 660° C. and do not show thermal degradation of coating-to-substrate adhesion strength. The coating to substrate adhesion strengths of the shields of the present invention is equal or greater than that of a stainless steel-aluminum interface in a prior art shield. In comparison to prior art shields, whose mechanical property deteriorates above 400° C., the invented shields can be used at extended chamber temperatures without sacrificing shield life. Furthermore, the coating materials used on the shields of the present invention are non-magnetic and thus, will not introduce complications concerning its RF or magnetic characteristics.

The thermal spray coatings can be fabricated using a plasma spray process or a twin-wire arc spray process. Depending on spray angle between the surface normal and spray gun axis and on spray parameters, the coating surface roughness typically lies between around 500 to around 1000 microinches for a plasma spray process and the coating surface roughness typically lies between around 1000 to around 2000 microinches for a twin-wire arc spray process. The high surface roughness of the spray coating will allow a large amount of deposition materials to adhere to the shields.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The drawings illustrate partial sectional side views of the structure of the invented shield and of an example of a PVD process chamber in which the invented shields are used. It is to be understood that the drawings illustrate only typical embodiments of the invention and are not to be considered limiting in their scope.

FIG. 1 depicts a partial sectional side view of an example PVD chamber using the invented shields for at least one of the following components: an upper shield, an inner shield, a lower shield, a shutter disk, a cover ring and a clamp ring;

FIG. 2 is a partial sectional side view of the layer structure of a PVD chamber shield having a substrate material, a reaction barrier layer over the substrate and a top coating layer according to one embodiment of the present invention;

FIG. 3A is a partial sectional side view of the layer structure of a PVD chamber shield having a thermal spray coating over a substrate material of stainless steel according to one embodiment of the present invention;

FIG. 3B is a partial sectional side view of the layer structure of a PVD chamber shield having a thermal spray coating over a substrate material of titanium according to one embodiment of the present invention; and

FIG. 3C is a partial sectional side view of the layer structure of a PVD chamber shield having a thermal spray coating over a substrate material of aluminum according to one embodiment of the present invention.

Similar reference characters refer to similar parts throughout the several views of the drawings.

### DETAILED DESCRIPTION OF THE INVENTION

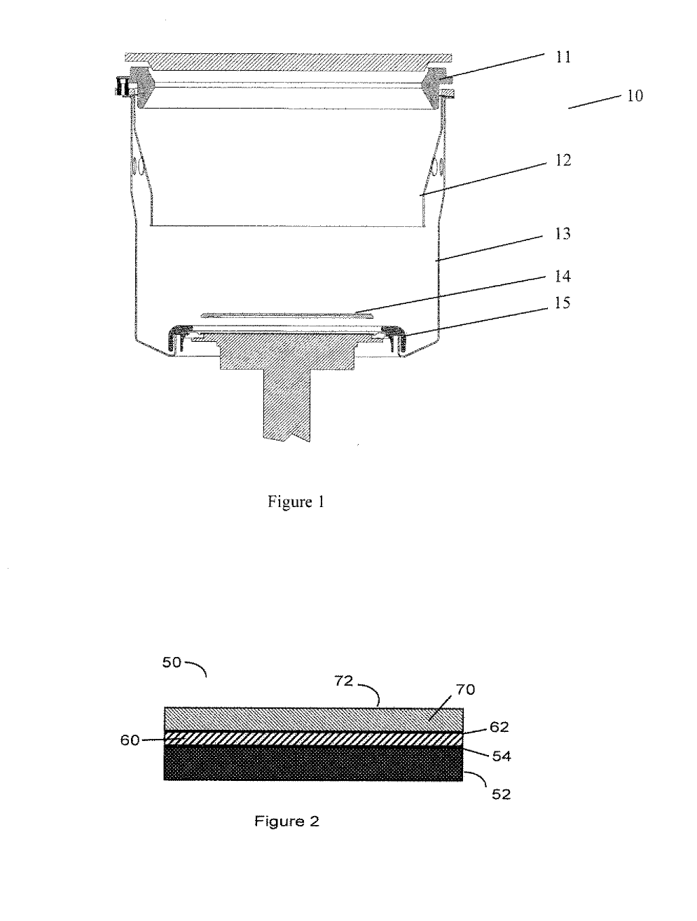

The invented PVD process chamber shield 10 (or PVD process chamber component) has enhanced thermal and mechanical stabilities and is used to contain deposition materials or residuals generated in the PVD process chamber. As an example, FIG. 1 illustrates a partial sectional side view of a PVD tantalum deposition chamber 20. In this illustration, the chamber shields 10 include an upper floating shield 11, an inner shield 12, a lower shield 13, a shutter disk 14 and a cover ring 15. The current invention can apply to one or all of these shields components. Since each shield component experiences a different heating effect from the chamber plasma; however, different shields may reach different temperatures during operation.

The present invention discloses two embodiments of shields. The first embodiment of shield 50, as illustrated in FIG. 2, consists of a stainless steel substrate material 52, a reaction barrier layer 60 and a top aluminum thermal spray coating 70. To fabricate the first embodiment of shield 50, a machined or a refurbished stainless steel part 52 is first cleaned; for example, in an alkaline cleaner bath with ultrasonic excitation and rinsed, for example in deionized water. Then, the surface 54 of the stainless steel substrate 52 to be coated is roughened; for example, by grit blasting. The grit blast process is performed by blasting a hard medium, such as aluminum oxide beads, toward the stainless steel surface 54 using compressed clean dry air. The purpose of the grit blast surface treatment is to roughen the stainless steel surface 54 to a desirable surface roughness average above about 150 microinches. The stainless steel surface 54 roughness is an important parameter affecting the adhesion between the stainless steel substrate 52 and coating materials since mechanical interlocking is one of the key adhesion mechanisms. The size of the aluminum oxide beads may be selected to achieve the desired roughness. Typical bead sizes are about mesh size 46 or about mesh size 24. Also, the pressure of the blasting air may be selected so as to achieve the desired surface roughness. Typically, air pressures from about 40 to about 80 psi may be used.

A reaction barrier layer 60 is then applied on the top of at least one portion of the grit-blasted textured stainless steel surface 54. A preferred method of producing the reaction barrier layer 60 is by a plasma spray or a twin wire arc spray. The material for the reaction barrier layer 60 comprises at least one of the following materials: titanium, a non-magnetic nickel-chromium alloy (major constituents of around 70% by weight of nickel and around 20% by weight of chromium) or a non-magnetic cobalt-chromium-molybdenum alloy (major constituents of around 60% by weight of cobalt, around 26% by weight of chromium and around 7% by weight of molybdenum). The average thickness of this barrier layer 60 is preferably from around 0.001 to around 0.010 inches thick or, more preferably, about 0.003 to 0.005 inches thick. When coating the stainless steel substrate 52 with the reaction barrier material 60, it is desirable to maintain a minimum thickness of at least about 0.001 inches so as to maintain the barrier function of this barrier layer 60. Also, it is desirable for the surface 62 roughness of the reaction barrier layer 60 to be greater than about 300 microinches to ensure adequate adhesion to the top coating 70. An aluminum top coating 70 is applied on the surface 62 of the reaction barrier layer 60. The top coating 70 is applied by a thermal spray method on the barrier layer 60. A preferred method for the thermal spray coating 70 is the use of a plasma spray process or a twin-wire arc spray process to generate a coating 70 having a thickness around 0.005 to around 0.020 inches thick or, more preferably, about 0.008 to about 0.012 inches thick. Depending on spray angle between the surface normal and spray gun axis and on spray parameters, the surface 72 roughness of the coating 70 lies between around 500 to around 1000 microinches for a plasma spray process, and the surface 72 roughness of the coating 70 lies between around 1000 to around 2000 microinches for a twin-wire arc spray process. These surface 72 roughness values are desirable to allow a large amount of deposition materials to adhere to this first embodiment of shields 50.

The material for the reaction barrier layer 60 is so chosen that it will not lead to intermetallic phase formation between the substrate 52 and the barrier layer 60 or between the top coating 70 and the barrier layer 60 at temperatures in the range of about 400 to around 660° C. In addition, the reaction barrier layer 60 will not reduce the adhesion strength between the two interfaces. In comparison to a prior art shield, whose mechanical property deteriorates after subjecting to a temperature above about 400° C., the new shield 50 can be used at extended chamber temperatures without sacrificing shield life. The material used for the reaction barrier layer 60 is non-magnetic and the addition of this layer 60 does not affect the shield's RF or magnetic characteristics.

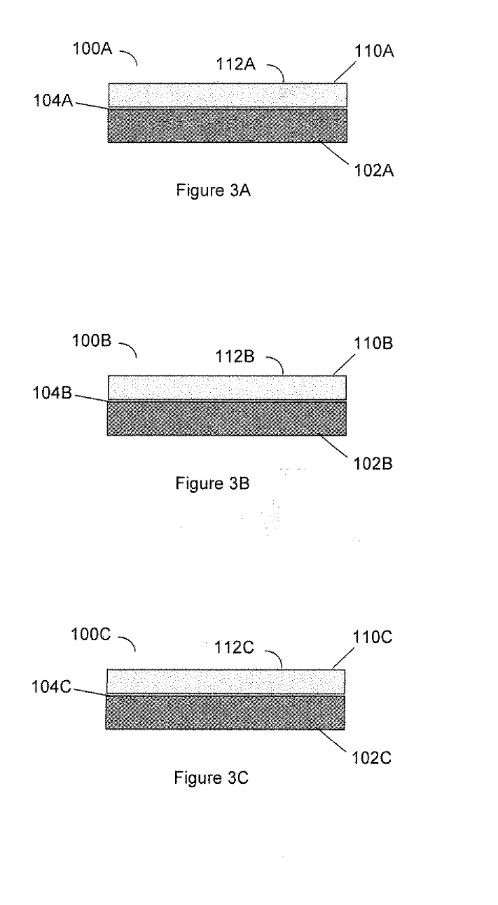

The second embodiment of shield 100, as illustrated in FIGS. 3A to 3C, consists of a substrate 102 and a coating 110, with substrate-coating material 102 combinations chosen to allow no new intermetallic phase to form at the substrate-coating interface. The following materials combinations are used:
(1) As shown in FIG. 3A, the shield 100A has a substrate material 102A of stainless steel and a thermal-spray coating 110A of around 0.005 to around 0.020 inches thick or, more preferably, about 0.008 to about 0.012 inches thick of one of the following materials: titanium, a non-magnetic nickel-chromium alloy (major constituents of around 70% by weight of nickel and around 20% by weight of chromium) or a non-magnetic cobalt-chromium-molybdenum alloy (major constituents of around 60% by weight of cobalt, around 26% by weight of chromium and around 7% by weight of molybdenum);
(2) As shown in FIG. 313, the shield 100B has a substrate material 102B of titanium and a thermal-spray coating 110B of aluminum with a thickness around 0.005 to around 0.020 inches thick or, more preferably, about 0.008 to about 0.012 inches thick; or
(3) As shown in FIG. 3C, the shield 100C has a substrate material 102C of aluminum and a thermal-spray coating 110C of titanium with a thickness around 0.005 to around 0.020 inches thick or, more preferably, about 0.008 to about 0.012 inches thick.

To fabricate the second embodiment of shield 100 (100A, 100B or 100C), a machined or a refurbished shield 100 with one of the above substrate materials 102 (102A, 102B or 102C) is first ultrasound cleaned; for example, in an alkaline cleaner bath with ultrasonic excitation and rinsed; for example, in deionized water. Then, the surface 104 (104A, 104B or 104C) of the substrate 102 to be coated is roughened; for example, by grit blasting. The grit blast process is performed by blasting a hard medium, such as aluminum oxide beads, toward the surface 104 using compressed clean dry air. The purpose of the grit blast surface treatment is to roughen the surface 104 to a desirable surface roughness average above about 150 microinches. The surface roughness 104 is an important parameter affecting the adhesion between the substrate 102 and coating materials 110 (110A, 110B or 110C) since mechanical interlocking is one of the key adhesion mechanisms. The size of the aluminum oxide beads may be selected to achieve the desired roughness. Typical bead sizes are about mesh size 46 or about mesh size 24. Also, the pressure of the blasting air may be selected so as to achieve the desired surface roughness. Typically, air pressures from about 40 to about 80 psi may be used.

The coating 110 is applied by a thermal spray method on at least one portion of the grit blasted surfaces 104 of the substrate material 102, A preferred method for the thermal spray coating 110 is the use of a plasma spray process or a twin-wire arc spray process to generate a coating 110 having a thickness around 0.005 to around 0.020 inches thick or, more preferably, about 0.008 to about 0.012 inches thick. Depending on spray angle between the surface normal and spray gun axis and on spray parameters, the surface 112 (112A, 112B or 112C) roughness of the coating 110 lies between around 500 to around 1000 microinches for a plasma spray process, and the surface 112 roughness of the coating 110 lies between around 1000 to around 2000 microinches for a twin-wire arc spray process. These surface 112 roughness values are desirable to allow a large amount of deposition materials to adhere to this second embodiment of shields 100.

The material combinations between the substrate 102 and the coating 110 for this second embodiment of shield 100 of the present invention do not lead to intermetallic phase formation at temperatures around 400 to around 660° C. and do not show thermal degradation of the coating-to-substrate adhesion strength. The adhesion strength of these bi-materials is equal or greater than that of an aluminum-stainless steel interface in a conventional shield. In comparison to prior art shields, whose mechanical property deteriorates above around 400° C., the invented shield can be used at extended chamber temperatures without sacrificing shield life. Furthermore, the coating materials used are non-magnetic and thus, will not introduce complication concerning its RF characteristics.

A widely used thermal spray coating method is a twin-wire arc spray. In this method, two metal wires connected to different polarities of an electrical power supply are brought in proximity to trigger an electrical arcing and to melt two metal wires that are consumable. At the same time, a compressed carrier gas (normally a clean dry air) atomizes and propels the molten metal away from the arc gun and projects the melt onto a surface to be coated. The molten or partially molten metal droplets impact on the surface of a shield and solidify to form units (lamellae) of a thermal spray coating. The two metal wires are continuously fed to sustain the coating process. The rate of deposition is proportional to the wire feed rate that increases with the set value of electrical current. The surface roughness of the coating is mainly determined by the pressure of the carrier gas and by the spray angle (the angle between the axis of the spray gun and the normal of the surface to be coated). The arc spray gun can be attached to a robot that is then programmed to produce a consistent and uniform coating for a given geometry of a shield.

Plasma spray is another commonly used thermal spray method. Plasma spray involves the generation of a plasma flame facilitated by pressurized and an electrically energized gas mixture such as argon-hydrogen or argon-helium. The plasma flame can generate a high temperature zone (as high as 20,000° K) with high heat content and thus, can spray materials of high melting temperature. A powder port located adjacent to the plasma flame continuously feeds powders of the coating material to the flame. The powder particles entering the plasma flame get melted or partially melted and at the same time are propelled by the pressurized plasma flame towards the surface to be coated. The molten or partially molten droplets impact and solidify at the surface, forming units of the coating with their thermal and kinetic energies partially transforming to the energy of adhesion to the underlying substrate. The powder feed can be controlled to a given rate to yield a certain coating rate for a given speed of gun movement that can be controlled using a robot. A uniformly sized powder can be used to produce a coating with a uniform surface morphology. In comparison to arc spray, plasma spray is generally more expensive and yields a less rough surface with more uniform surface morphology and can coat both metal and ceramic materials.

The thickness of a thermal spray coating can be measured by a variety of techniques, such as using microscopy analysis on a cross-section sample, using a micrometer to determine sample or part thickness before and after coating and using commercially available coating thickness gages. The surface roughness average of a coating can be measured using a surface profilometer which involves scanning a surface by a diamond tip to generate a surface morphology profile. A recognized ASME/ANSI B46.1-2002 standard is used to define the measurement of the surface roughness average. For a surface roughness average greater than 400 microinches, a cut-off length of 0.3 inches is used.

The strength of adhesion of a coating to a substrate material is evaluated by an adhesion pull test. In a pull test, the coating with a given area is attached by an epoxy to a piston of a tester. The underlying substrate material is attached to the other piston of a tester by an epoxy or by a pin through a hole made in the substrate material. The tester's two pistons are then uniaxially pulled apart at a given rate of displacement. The force or stress acting on the pistons is recorded continuously. The minimum stress that is required to cause the delamination of the coating from the substrate is taken as the strength of adhesion of the coating to the substrate. To accurately determine the adhesion, the epoxy is so chosen that the strength of the bulk epoxy and the strength of adhesion of epoxy to the coating are much greater than the strength of adhesion of the coating to the substrate.

The impact of high temperature on the adhesion strength was evaluated for different combinations of substrate and coating materials used in the two embodiments of invented shields, as well as for aluminum-stainless steel bi-material samples representing the conventional shield. Coupons of these material combinations were prepared and were heat-treated at 250° C., 350° C., 450° C. and 550° C. under vacuum for one hour. Adhesion pull tests were then carried out on these samples as well as on samples without heat treatment. All samples representing the coating-substrate material combinations for the invented shields yielded similar adhesion strength of 7 to 9 kpsi for the different heat treatment temperatures. The strengths are similar to the strength of 7-8 kpsi for the samples of aluminum-stainless steel bi-material representing the conventional shield when no heat treatment was performed, but are much greater than that of 3 to 4 kpsi for the conventional shield samples when heat treatment at 450° C. and 550° C. was performed.

Scanning electron microscopy (SEM) and energy dispersive spectroscopy (EDS) were used to analyze cross sectional metallurgical specimens. The specimens were prepared by cutting samples perpendicular to the coating to include the bi-material interface(s) and by subsequent fine polish. The analysis on the heat-treated samples determines if intermetallic phase(s) forms at the interface(s). Based on the SEM-EDS observations on cross section of the invented shield, no intermetallic phase was observed at any of the bi-material interfaces for the two embodiments of invented shields after the shields had been heated above 400° C. This is in contrast to the conventional aluminum coated stainless steel shield for which SEM-EDS analysis on samples after experiencing a fast burn-in cycle or being heat-treated above 400° C. revealed that, as a result of the excess heating, a layer of aluminum-iron-nickel intermetallic phase formed at the interface between the stainless-steel substrate and the aluminum arc spray coating. Associated with the intermetallic phase formation, it was also observed that adjacent to the intermetallic layer, a region with large population of voids is formed in the aluminum spray coating. Such a porous layer was not observed in shields or coupons that were only subjected to temperatures lower than 400° C. This layer with large population of voids weakens the aluminum are spray coating adhesion to the underlying stainless steel substrate.

The first embodiment of the invented shields use a reaction barrier layer that prohibits the intermetallic phase layer formation between stainless steel and aluminum. The second embodiment of invented shields use material combinations that any intermetallic phase would not be thermodynamically stable to form at the interface. The invented shield materials have thermal and structural stability, as well as good bulk and interface strengths to outperform the conventional aluminum arc sprayed stainless steel shields of the prior art during PVD processes requiring elevated chamber temperature.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A shield component for a plasma processing system comprising a substrate, a reaction barrier layer, and a top coating.

2. The shield component according to claim 1 wherein said reaction barrier layer further comprising a material that does not chemically react to form a new intermetallic phase with said substrate or said top coating at a temperature range of about 400 to 660° C.

3. The shield component according to claim 1 wherein said substrate further comprises stainless steel.

4. The shield component according to claim 1 wherein said reaction barrier layer further comprises titanium.

5. The shield component according to claim 1 wherein said reaction barrier layer further comprises a non-magnetic nickel-chromium alloy.

6. The shield component according to claim 5 wherein said non-magnetic nickel-chromium alloy further comprises about 70% by weight of nickel and about 20% by weight of chromium.

7. The shield component according to claim 1 wherein said reaction barrier layer further comprises a non-magnetic cobalt-chromium-molybdenum alloy.

8. The shield component according to claim 7 wherein said non-magnetic cobalt-chromium-molybdenum alloy further comprises about 60% by weight of cobalt, about 26% by weight of chromium and about 7% by weight of molybdenum.

9. The shield component according to claim 1 wherein said top coating further comprises aluminum.

10. The shield component according to claim 1 wherein said reaction barrier layer having a thickness of about 0.001 to about 0.010 inches.

11. The shield component according to claim 1 wherein said top coating having a thickness of about 0.005 to about 0.020 inches.

12. The shield component according to claim 1 wherein said top coating having a surface roughness average of about 500 to about 2000 microinches.

13. A shield component for a plasma processing system comprising a substrate and a coating wherein said substrate does not chemically react with said coating to form a new intermetallic phase at a temperature range of about 400 to 660° C.

14. The shield component according to claim 13 wherein said substrate further comprises stainless steel and wherein said coating further comprises titanium.

15. The shield component according to claim 13 wherein said substrate further comprises stainless steel and wherein said coating further comprises a non-magnetic nickel-chromium alloy

16. The shield component according to claim 15 wherein said non-magnetic nickel-chromium alloy further comprises about 70% by weight of nickel and about 20% by weight of chromium.

17. The shield component according to claim 13 wherein said substrate further comprises stainless steel and wherein said coating further comprises a non-magnetic cobalt-chromium-molybdenum alloy.

18. The shield component according to claim 17 wherein said non-magnetic cobalt-chromium-molybdenum alloy further comprises about 60% by weight of cobalt, about 26% by weight of chromium and about 7% by weight of molybdenum.

19. The shield component according to claim 13 wherein said substrate further comprises titanium and wherein said coating further comprises aluminum.

20. The shield component according to claim 13 wherein said substrate further comprises aluminum and wherein said coating further comprises titanium.

21. The shield component according to claim 13 wherein said coating having a thickness of about 0.005 to about 0.020 inches.

22. The shield component according to claim 13 wherein said coating having a surface roughness average of about 500 to about 2000 microinches.
